(19) United States
(12) Patent Application Publication
(10) Pub. No.: US 2025/0175424 A1
(43) Pub. Date: May 29, 2025

(54) IP ROUTING AND FORWARDING OPERATION AND MANAGEMENT OF IP ROUTER NODE

(71) Applicant: Nokia Solutions and Networks Oy, Espoo (FI)

(72) Inventors: Hua CHAO, Shanghai (CN); Markus Sakari ISOMÄKI, Espoo (FI); Matti Einari LAITILA, Oulu (FI); Laurent THIÉBAUT, Massy (FI)

(21) Appl. No.: 18/861,850

(22) PCT Filed: May 5, 2022
(86) PCT No.: PCT/CN2022/091054

§ 371 Date: Oct. 30, 2024

(51) Int. Cl. H04L 45/74; H04W 40/24

(52) U.S. Cl. CPC H04L 45/74; H04W 40/24

(57) ABSTRACT

Embodiments of the present disclosure relate to devices, methods, apparatuses and computer readable storage media for IP routing and forwarding operation and management of an IP router node. A core network entity obtains a first set of IP routing or forwarding information about at least one IP interface in a first IP router node from at least one of the following: at least one user plane entity in the first IP router node, at least one control plane entity in the first IP router node, or an IP router controller. In turn, the core network entity determines a second set of IP routing or forwarding information about the first IP router based on at least one of the first set of IP routing or forwarding information and first static routing information preconfigured on the core network entity, the at least one IP interface connecting the first IP router node to a second set of IP entities and/or to a third set of IP entities. Each of the IP entities comprises an IP node or an IP host.

### FIELD

Embodiments of the present disclosure generally relate to the field of telecommunication and, in particular, to apparatuses, methods, devices and computer readable storage media for Internet Protocol (IP) routing and forwarding operation and management of an IP router node.

### BACKGROUND

Since the 3rd Generation Partnership Project (3GPP) Release 16, 3GPP has been considering how to define technical building blocks in cellular networks for the delivery of reliable and predictable network services defined by other standardization groups, such as Institute of Electrical and Electronics Engineers (IEEE) Time-Sensitive Networking (TSN).

In 3GPP Release 16, integration of layer 2 (L2) Ethernet TSN features into the Fifth Generation System (5GS) was introduced as an essential part of Ultra Reliable and Low Latency Communication (URLLC). 5GS Bridge utilizes the fully centralized configuration model as specified in IEEE 802.1 standards.

In 3GPP Release 17, generalized Time Sensitive Communication (TSC) support was introduced to provide deterministic transmission capability without relying on TSN specific functions. Since then, 5GS has defined generic enablers for TSC and native TSC. A new Network Function (NF) called Time Sensitive Communication and Time Synchronization Function (TSCTSF) is introduced to take care of time synchronization, individual Quality of Service (QOS) parameters, and TSC Assistance Container (TSCAC) determination. TSCTSF discovers ingress/egress port capabilities, configures them and get notifications about configuration updates from them.

The Internet Engineering Task Force (IETF) is another standardization group working to deliver deterministic services over layer 3 (L3) networking (i.e., IP routers) and wireless networks in the respective Deterministic Networking (DetNet) Working Group. The DetNet network comprises a DetNet controller and IP router nodes. DetNet controller may collect topology and capability and resource availability information from the IP router nodes. With this information and ability to configure explicit routes and reserve resources along the route, the DetNet controller may calculate and setup End to End (E2E) deterministic path for DetNet traffic flows according to requests from applications thus controlling the IP router.

For 3GPP Release 18, a new study item, FS_DetNet “Extensions to the TSC Framework to support DetNet” was approved. The objective of the study item is to study whether and how to enable 3GPP support for DetNet such that a mapping is provided between the DetNet controller and the 5GS. The study considers 5GS acting as one of the IP router nodes in the DetNet domain. Hereinafter, a 5GS acting as an IP router node is also referred to as a 5GS DetNet Node.

The 5GS DetNet Node needs to expose its routing information to the DetNet controller. Inside a 5GS DetNet Node, it is TSCTSF that is responsible for the interaction with the DetNet controller. Therefore, the TSCTSF needs to report to the DetNet controller information about the 5GS DetNet Node including its current routing and topology information. However, there is no way for the TSCTSF to learn IP routing information of all the interfaces of the 5GS DetNet Node.

### SUMMARY

Example embodiments of the present disclosure provide an improved solution for IP routing and forwarding operation and management of an IP router node.

In a first aspect, there is provided a core network entity. The core network entity comprises at least one processor and at least one memory including computer program code. The at least one memory and the computer program code are configured to, with the at least one processor, cause the core network entity in a first set of entities acting as a first IP router node to: obtain a first set of IP routing or forwarding information about at least one IP interface in the first IP router node from at least one of the following: at least one user plane entity in the first IP router node, at least one control plane entity in the first IP router node, or an IP router controller; and determine a second set of IP routing or forwarding information about the first IP router based on at least one of the first set of IP routing or forwarding information and first static routing information preconfigured on the core network entity, the at least one IP interface connecting the first IP router node to a second set of IP entities and/or to a third set of IP entities, each of the IP entities comprising an IP node or an IP host.

In a second aspect, there is provided a device. The device comprises at least one processor and at least one memory including computer program code. The at least one memory and the computer program code are configured to, with the at least one processor, cause the device in a first set of entities acting as a first IP router node to: transmit, to a core network entity in the first IP router node, a first subset of IP, routing or forwarding information about at least one first IP interface associated with the device; receive, from the core network entity, a third subset of IP routing or forwarding information about the at least one first IP interface, the third subset of IP routing or forwarding information being determined based on at least one of the first set of IP routing or forwarding information and first static routing information preconfigured on the first core network entity within the first IP router node and process an IP packet to or from the at least one first IP interface based on the third subset of IP routing or forwarding information.

In a third aspect, there is provided a device. The device comprises at least one processor and at least one memory including computer program code. The at least one memory and the computer program code are configured to, with the at least one processor, cause the device in a first set of entities acting as a first IP router node to: transmit, to a core network entity in the first IP router node, a second subset of IP, routing or forwarding information about at least one second IP interface associated with the device; receive, from the core network entity, a fourth subset of IP routing or forwarding information about the at least one second IP interface, the fourth subset of IP routing or forwarding information being determined based on at least one of the first set of IP routing or forwarding information and first static routing information preconfigured on the core network entity; and process an IP packet to or from the at least one second IP interface based on the fourth subset of IP routing or forwarding information.

In a fourth aspect, there is provided a method. The method comprises: obtaining, at a core network entity in a first set of entities acting as a first IP router node, first set of IP routing or forwarding information about at least one IP interface in the first IP router node from at least one of the following: at least one user plane entity in the first IP router node, at least one control plane entity in the first IP router node, or an IP router controller; and determining a second set of IP routing or forwarding information about the first IP router based on at least one of the first set of IP routing or forwarding information and first static routing information preconfigured on the core network entity, the at least one IP interface connecting the first IP router node to a second set of IP entities and/or to a third set of IP entities, each of the IP entities comprising an IP node or an IP host.

In a fifth aspect, there is provided a method. The method comprises: transmitting, from a device in a first set of entities acting as a first IP router node to a core network entity in the first IP router node, a first subset of IP routing or forwarding information about at least one first IP interface associated with the device; receiving, from the core network entity, a third subset of IP routing or forwarding information about the at least one first IP interface, the third subset of IP routing or forwarding information being determined based on at least one of the first set of IP routing or forwarding information and first static routing information preconfigured on the first core network entity within the first IP router node and processing an IP packet to or from the at least one first IP interface based on the third subset of IP routing or forwarding information.

In a sixth aspect, there is provided a method. The method comprises: transmitting, from a device in a first set of entities acting as a first IP router node to a core network entity in the first IP router node, a second subset of IP routing or forwarding information about at least one second IP interface associated with the device; receiving, from the core network entity, a fourth subset of IP routing or forwarding information about the at least one second IP interface, the fourth subset of IP routing or forwarding information being determined based on the at least one of the first set of IP routing or forwarding information and first static routing information preconfigured on the core network entity; and processing an IP packet to or from the at least one second IP interface based on the fourth subset of IP routing or forwarding information.

In a seventh aspect, there is provided an apparatus. The apparatus comprises: means for obtaining, at a core network entity in a first set of entities acting as a first IP router node, first set of IP routing or forwarding information about at least one IP interface in the first IP router node from at least one of the following: at least one user plane entity in the first IP router node, at least one control plane entity in the first IP router node, or an IP router controller; and means for determining a second set of IP routing or forwarding information about the first IP router based on at least one of the first set of IP routing or forwarding information and first static routing information preconfigured on the core network entity, the at least one IP interface connecting the first IP router node to a second set of IP entities and/or to a third set of IP entities, each of the IP entities comprising an IP node or an IP host.

In an eighth aspect, there is provided an apparatus. The apparatus comprises: means for transmitting, from a device in a first set of entities acting as a first IP router node to a core network entity in the first IP router node, a first subset of IP routing or forwarding information about at least one first IP interface associated with the device; means for receiving, from the core network entity, a third subset of IP routing or forwarding information about the at least one first IP interface, the third subset of IP routing or forwarding information being determined based on at least one of the first set of IP routing or forwarding information and first static routing information preconfigured on the first core network entity within the first IP router node and means for processing an IP packet to or from the at least one first IP interface based on the third subset of IP routing or forwarding information.

In a ninth aspect, there is provided an apparatus. The apparatus comprises: means for transmitting, from the apparatus in a first set of entities acting as a first IP router node to a core network entity in the first IP router node, a second subset of IP routing or forwarding information about at least one second IP interface associated with the apparatus; means for receiving, from the core network entity, a fourth subset of IP routing or forwarding information about the at least one second IP interface, the fourth subset of IP routing or forwarding information being determined based on the at least one of the first set of IP routing or forwarding information and first static routing information preconfigured on the core network entity; and means for processing an IP packet to or from the at least one second IP interface based on the fourth subset of IP routing or forwarding information.

In a tenth aspect, there is provided a computer readable medium. The non-transitory computer readable medium comprises program instructions for causing an apparatus to perform the method according to any of the fourth, fifth and sixth aspects.

It is to be understood that the summary section is not intended to necessarily identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example implementations will now be described with reference to the accompanying drawings, where:

FIG. 1 illustrates an example communication environment in which embodiments of the present disclosure can be implemented;

FIG. 2 illustrates a flowchart of an example method implemented at a core network entity in accordance with some example embodiments of the present disclosure;

FIGS. 3 to 6 illustrate a signaling chart illustrating a process for IP routing and forwarding operation and management of an IP router node in accordance with some example embodiments of the present disclosure, respectively;

FIG. 7 illustrates another example communication environment in which embodiments of the present disclosure can be implemented;

FIG. 8 illustrates an example of determining an IP routing status base for the first IP router node in accordance with some embodiments of the present disclosure;

FIG. 9 illustrates a flowchart of an example method implemented at a device in accordance with some example embodiments of the present disclosure;

FIG. 10 illustrates a flowchart of an example method implemented at a device in accordance with some example embodiments of the present disclosure;

FIG. 11 illustrates a simplified block diagram of an apparatus that is suitable for implementing example implementations of the present disclosure; and

FIG. 12 illustrates a block diagram of an example computer readable medium in accordance with example implementations of the present disclosure.

Throughout the drawings, the same or similar reference numerals represent the same or similar element, unless otherwise provided.

### DETAILED DESCRIPTION

Principles of the present disclosure will now be described with reference to some example implementations. It is to be understood that these implementations are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as, but not limited to, 5G systems, Long Term Evolution (LTE), LTE-Advanced (LTE-A), Wideband Code Division Multiple Access (WCDMA), High-Speed Packet Access (HSPA), Narrow Band Internet of Things (NB-IoT), Wi-Fi and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, 5G new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned systems.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node. Even though the description and drawing refer to UE and DS-TT using NR and RAN to connect to the rest of the 5GS, the mechanism described in this invention may apply in case of other kind of access networks such as untrusted Non 3GPP AN (using a N3IWF instead of a RAN), trusted Non 3GPP AN (using a TNGF instead of a RAN), or wireline access (using a W-AGF instead of a RAN).

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

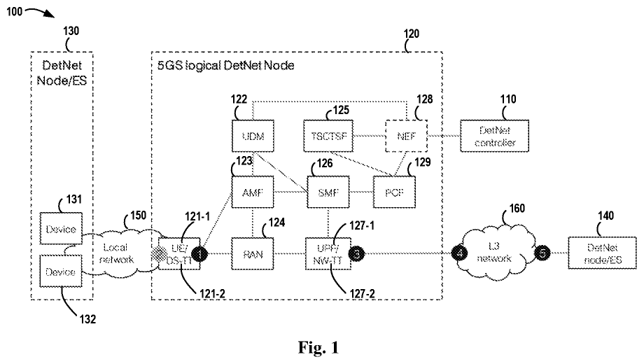

FIG. 1 illustrates an example communication environment 100 in which embodiments of the present disclosure can be implemented.

As shown in FIG. 1, the communication environment 100 comprises an IP router controller 110, a first set of entities 120, a second set of IP entities 130 and a third set of IP entities 140. The first set of entities 120 acts as a first IP router node. Thus, hereinafter, the first set of entities 120 may be referred to as the first IP router node 120.

In some embodiments, the first set of entities 120 may be implemented as a 5GS. In such embodiments, the 5GS may act as the first IP router node 120.

Each of the IP entities in the second and third sets comprises an IP node or an IP host. In other words, the second set of IP entities 130 comprises at least one IP node and/or at least one IP host, and the third set of IP entities 140 comprises at least one IP node and/or at least one IP host.

In some embodiments, the communication environment 100 may be implemented as a DetNet. In such embodiments, the first set of entities 120 may be implemented as a DetNet Node, each of the second set of IP entities 130 and the third set of IP entities 140 may be implemented as a DetNet Node or DetNet End System(ES), and the IP router control 110 may be implemented as a DetNet controller. In such embodiments, the first set of entities 120 may be referred to as a first IP router node 120, the second set of IP entities 130 and the third set of IP entities 140 may be referred to as a DetNet Node 130 and a DetNet Node 140, respectively, and the IP router control 110 may be implemented as a DetNet controller 110.

In embodiments where 5GS acts the first DetNet Node 120, the first DetNet Node 120 may be referred to as 5GS logical DetNet Node 120.

Hereinafter, some embodiments of the present disclosure will be described in the context of 5GS logical DetNet Node. However, the solution of the present disclosure may be applied to other communication environment than the DetNet.

The IP router controller 110 may collect topology, capability and resource availability information from the first IP router node 120, the second set of IP entities 130 and the third set of IP entities 140. With this information and ability to configure explicit routes and reserve resources along a route, the IP router controller 110 may calculate and set up E2E deterministic path for DetNet traffic flows according to requests from applications.

The second set of IP entities 130 may comprise devices 131 and 132.

In some embodiments, the granularity of the 5GS logical DetNet Node may be per UPF for each network instance. Therefore, the first IP router node 120 may comprise a single UPF 127-1 and one or more terminal devices. FIG. 1 shows, just by way of example, the first IP router node 120 comprises a terminal device 121-1. In addition, the first IP router node 120 may comprise a Unified Data Management (UDM) entity 122, an Access and Mobility Management Function (AMF) entity 123, a Radio Access Network (RAN) 124, a TSCTSF 125, a Session Management Function (SMF) entity 126, a Network Exposure Function (NEF) entity 128, and a Policy Control Function (PCF) entity 129.

In some embodiments, the terminal device 121-1 may provide the first IP router node 120 with at least one first IP interface which connects the first IP router node 120 to the second set of IP entities 130 or to IP devices 131 and 132. Each of the IP devices 131 and 132 may be an IP router or IP host.

In some embodiments, the second set of IP entities 130 may comprise a plurality of IP entities and the at least one first IP interface may comprise a first plurality of IP interfaces. In such embodiments, each of the first IP interface connects the first IP router node 120 to one of the IP entities in the second set of IP entities 130.

In some embodiments, the terminal device 121-1 may be associated with or accompanied by one or more Device Side TSN translator (DS-TT) devices. Each of the DS-TT devices may provide one of the at least one first IP interface. In the example as shown in FIG. 1, the terminal device 121-1 may be associated with a DS-TT device 121-2, and the DS-TT device 121-2 provides an IP interfaces #2. In this way, the first IP router node 120 may communicate with the second set of IP entities 130 or with IP devices 131 and 132 through a local network 150 via the IP interfaces #2.

In some embodiments, the UPF entity 127-1 may provide the first IP router node 120 with at least one second IP interface which connects the first IP router node 120 to the third set of IP entities 140.

In some embodiments, the third set of IP entities 140 may comprise a plurality of IP entities and the at least one second IP interface may comprise a second plurality of IP interfaces. In such embodiments, each of the second IP interface connects the first IP router node 120 to one of the IP entities in the third set of IP entities 140.

In some embodiments, the UPF entity 127-1 may be associated with or accompanied by a Network Side TSN translator (NW-TT) device. The DS-TT device may provide the at least one second IP interface. In the example as shown in FIG. 1, the UPF entity 127-1 is associated with an NW-TT 127-2, and the NW-TT 127-2 provides an IP interfaces #3. In this way, the first IP router node 120 may communicate with the third set of IP entities 140 through an L3 network 160 via the IP interfaces #3.

Hereinafter, for simplicity, each of the at least one first IP interface (such as the IP interfaces #2) is also referred to as UE/DS-TT DetNet interface, and each of the at least one second IP interface (such as the IP interfaces #3) is also referred to as UPF/NW-TT DetNet interface.

It is to be understood that the number of the IP router nodes in the communication environment 100 and the numbers of the terminal devices and network elements in the first IP router node 120 as shown in FIG. 1 are only for the purpose of illustration without suggesting any limitations. The communication environment 100 may include any suitable number of IP router nodes, terminal devices and network elements adapted for implementing embodiments of the present disclosure.

The first IP router node 120 may need to expose its routing information to the IP router controller 110. Inside the first IP router node 120, the TSCTSF 125 may be responsible for the interaction with the IP router controller 110. Therefore, the TSCTSF 125 may need to report to the IP router controller 110 information about the first IP router node 120. For example, the information about the first IP router node 120 may comprise its current routing and topology information.

To guarantee the IP packet forwarding happen correctly within a 5GS DetNet Node, IP routing or forwarding information needs to be managed in three places in such a way that the configuration in them matches with the routing view the TSCTSF has for the 5GS DetNet Node.

First, the UPF device may need to be configured to forward packets that are destined to be sent out via a given UE/DS-TT interface to a Packet Data Unit (PDU) session associated with the UE/DS-TT. This may be done using the UPF Packet Detection Rule/Forwarding Action Rule rules. However, these would have to be correctly managed so that configuration in the UPF device matches with the 5GS DetNet Node routing state as seen by the TSCTSF.

Second, a terminal device or DS-TT itself may need to know the next hop IP address for any packet that it forwards from a UE/DS-TT interface in case the packet is destined to a different prefix than the UE/DS-TT interface has. This kind of forwarding table may also need to exist in the terminal device acting as a normal standalone IP router. However, because in the 5G DetNet Node context, the terminal device or DS-TT does not act as a standalone router but merely as an interface, it is expected that such forwarding table should be provided to it from the 5G core (5GC). This may cover the static routes configured on the 5GS IP router node manually (via OAM) and also the explicit routes provided by the IP router controller (DetNet controller) or any other IP Software Defined Network (SDN) controller.

Third, the UPF/NW-TT has IP routing or forwarding information relevant for the UPF device's N6 interface and the NW-TT DetNet interfaces. This IP routing or forwarding information may be statically configured at the UPF device/NW-TT or learned by IP routing protocols or algorithms by the UPF device/NW-TT, in which case the TSCTSF needs to learn it. It may also be managed by the TSCTSF, in which case the TSCTSF needs a way to do it.

Example embodiments of the present disclosure provide a solution for IP routing and forwarding operation and management of an IP router node so as to solve the above problems and one or more of other potential problems. According to the solution, a core network entity obtains a first set of IP routing or forwarding information about at least one IP interface in a first IP router node from at least one of the following: at least one user plane entity in the first IP router node, at least one control plane entity in the first IP router node, or an IP router controller. In turn, the core network entity determines a second set of IP routing or forwarding information about the first IP router based on at least one of the first set of IP routing or forwarding information and first static routing information preconfigured on the core network entity, the at least one IP interface connecting the first IP router node to a second set of IP entities and/or to a third set of IP entities.

With this solution, the core network entity may be aware of the IP routing or forwarding information of all interfaces in the first IP router node. In addition, the core network entity may influence the IP routing or forwarding information of the interfaces in the first IP router node in case it itself has static routing information to be added to the first IP router node based on local configuration on the first IP router node.

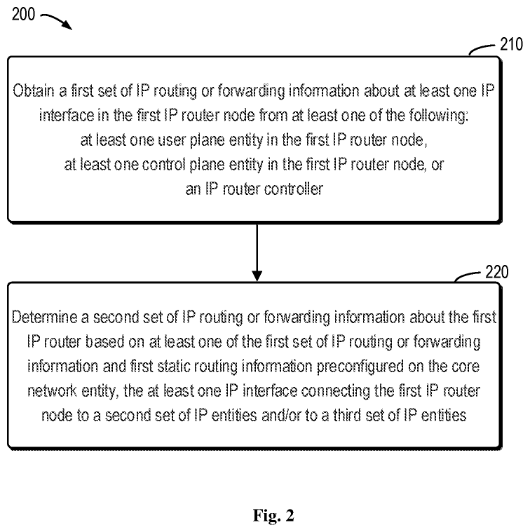

FIG. 2 shows a flowchart of an example method 200 implemented at a core network entity in accordance with some example embodiments of the present disclosure. For the purpose of discussion, the method 200 will be described from the perspective of the TSCTSF 125 with reference to FIG. 2. It will be understood that the method 200 may be implemented at other core network entity than the TSCTSF 125.

At block 210, the TSCTSF 125 obtains a first set of IP routing or forwarding information about at least one IP interface in the first IP router node from at least one of the following: at least one user plane entity in the first IP router node, at least one control plane entity in the first IP router node, or an IP router controller.

At block 220, the TSCTSF 125 determines a second set of IP routing or forwarding information about the first IP router based on at least one of the first set of IP routing or forwarding information and first static routing information preconfigured on the core network entity, the at least one IP interface connecting the first IP router node to a second set of IP entities and/or to a third set of IP entities.

In some embodiments, the first set of IP routing or forwarding information may be referred to as interface-level IP routing or forwarding information, and the second set of IP routing or forwarding information may be referred to as node-level IP routing or forwarding information. The interface-level IP routing or forwarding information may mean that it has been configured or obtained at the interface level (for example, by a single UE/DS-TT or UPF/NW-TT). The node-level IP routing or forwarding information may mean that it has been configured or obtained on the level of the first IP router node, for example, by a TSCTSF.

In some embodiments, the first set of IP routing or forwarding information may comprise a first subset of IP routing or forwarding information about at least one first IP interface associated with the terminal device 121-1 or with the DS-TT device 121-2. For example, the at least one first IP interface may comprise the IP interface #2 as described with reference to FIG. 1.

In some embodiments, alternatively or additionally, the first set of IP routing or forwarding information may comprise a second subset of IP routing or forwarding information about at least one second IP interface associated with the UPF entity 127-1 or the NF-TT device 127-2. For example, the at least one second IP interface may comprise the IP interface #3 as described with reference to FIG. 1.

In some embodiments, the at least one control plane entity may comprise the UDM entity 122 in the first IP router node 120. The TSCTSF 125 may obtain the first subset of IP routing or forwarding information by obtaining framed routes information associated with the terminal device 121-1 from the UDM entity 122. For example, the TSCTSF 125 may obtain the framed routes information directly from the UDM entity 122. Alternatively, the TSCTSF 125 may obtain the framed routes information from the UDM entity 122 via at least one of the SMF entity 126 or the PCF entity 129. In such embodiments, the framed routes information may comprise at least one of the following: a set of IP addresses reachable via the at least one first IP interface, a next hop IP address associated with the at least one first IP interface,, or an identifier for the at least one first IP interface.

In some embodiments, the TSCTSF 125 may generate, based on at least one of the first set of IP routing or forwarding information and the first static routing information, a third subset of IP routing or forwarding information about the at least one first IP interface associated with the terminal device 121-1 or with the DS-TT device 121-2.

In some embodiments, alternatively or additionally, the TSCTSF 125 may generate, based on at least one of the first set of IP routing or forwarding information and the first static routing information, a fourth subset of IP routing or forwarding information about the at least one second IP interface associated with the UPF entity 127-1 or the NF-TT device 127-2.

In some embodiments, the at least one user plane entity comprises the DS-TT device 121-2 and the TSCTSF 125 may obtain the first subset of IP routing or forwarding information from the DS-TT device 121-2.

In some embodiments, alternatively or additionally, the at least one user plane entity may comprise the terminal device 121-1 and the TSCTSF 125 may obtain the first subset of IP routing or forwarding information from the terminal device 121-1.

In some embodiments, alternatively or additionally, the at least one user plane entity may comprise the NW-TT device 127-2 and the TSCTSF 125 may obtain the second subset of IP routing or forwarding information from the NW-TT device 127-2.

In some embodiments, alternatively or additionally, the at least one user plane entity may comprise the UPF entity 127-1 and the TSCTSF 125 may obtain the second subset of IP routing or forwarding information from the UPF entity 127-1 via the SMF entity 126.

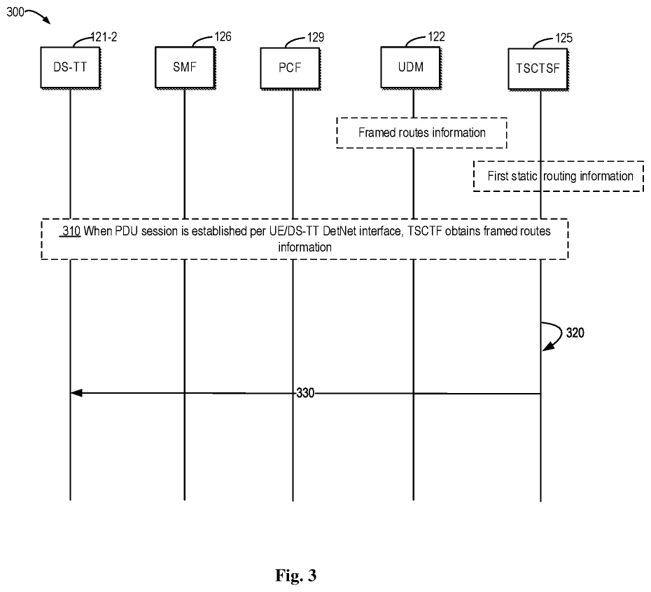

Hereinafter, some embodiments of the present disclosure will be described with reference to FIGS. 3 to 8.

FIG. 3 illustrates a signaling chart illustrating a process 300 for IP routing and forwarding operation and management of an IP router node in accordance with some example embodiments of the present disclosure. The process 300 may involve the DS-TT device 121-2, the SMF entity 126, the PCF entity 129, the UDM entity 122 and the TSCTSF 125 as illustrated in FIG. 1. Although the process 300 will be described in the communication environment 100 of FIG. 1, this process may be likewise applied to other communication scenarios.

In the process 300, the at least one first IP interface is associated with the DS-TT device 121-2. Each of the first and third subset of IP routing or forwarding information comprises static IP routing or forwarding information about the at least one first IP interface.

As shown in FIG. 3, the UDM entity 122 is preconfigured with the framed routes information associated with the terminal device 121-1, and the TSCTSF 125 is preconfigured with the first static routing information. When the terminal device 121-1 establishes a PDU session per UE/DS-TT DetNet interface (i.e., the first IP interface), the SMF entity 126 may obtain 310 the framed routes information associated with the terminal device 121-1 from the UDM entity 122 and provide the framed routes information via the PCF entity 129 to the TSCTSF 125 along with the interface number provided by the UPF entity 127-1.

In some embodiments, the first static routing information includes the next hop IP address for the at least one first IP interface associated with the DS-TT device 121-2. Based on the framed routes information and the first static routing information pre-configured on the TSCTSF 125, the TSCTSF 125 may determine 320 the third subset of IP routing or forwarding information about the at least one first IP interface associated with the DS-TT device 121-2.

In turn, the TSCTSF 125 may configure 330 the at least one first IP interface with the third subset of IP routing or forwarding information.

In some embodiments, in order to configure the at least one first IP interface, the TSCTSF 125 may transmit a Port Management Information Container (PMIC) 330 to the DS-TT device 121-2. The PMIC comprises the third subset of IP routing or forwarding information. The information 330 from the TSCTSF 125 to the DS-TT 121-2 may be transferred via the PCF 129, the SMF 126 and NAS signaling.

In some embodiments, the PMIC may comprise at least one of the following:
an IP address,
a range of IP addresses,
a length of an IP prefix,
a next hop IP address, or
a type of the IP routing or forwarding information.

In some embodiments, if the IP prefix is the same as the interface's own prefix, the PMIC may not comprise the next hop IP address.

In some embodiments, the type of the IP routing or forwarding information may indicate that the IP routing or forwarding information is static or dynamic IP routing or forwarding information. It will be understood that the static IP routing or forwarding information may be configured manually. The dynamic IP routing or forwarding information may be determined based on an IP routing protocol or algorithm.

In some embodiments, in order to configure one of the at least one first IP interface with the third subset of IP routing or forwarding information, the TSCTSF 125 may map the interface number related to the first IP interface corresponding to the PDU session to which the Application Function (AF) session is bound to and (possibly via the PCF129) update the SMF entity 126 that a set of IP addresses/prefixes should be associated to the PDU session for UPF forwarding. The TSCTSF 125 may update the DS-TT related to the PDU session with the IP prefix and a next hop IP address.

In some embodiments, in order to configure one of the at least one second IP interface with the third subset of IP routing or forwarding information, the TSCTSF 125 may update the NW-TT 127-2 with the IP prefix, IP interface and a next hop IP address via UMIC or PMIC. With UMIC, all interfaces could be carried in the same container rather than putting it interface-by-interface to PMIC.

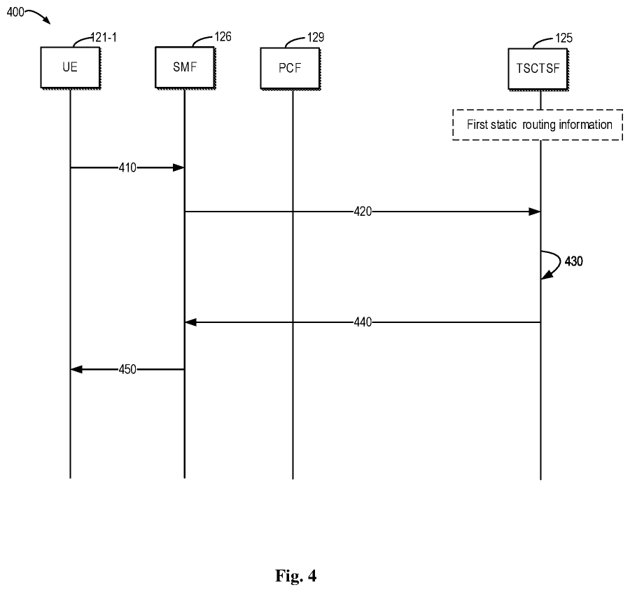

FIG. 4 illustrates a signaling chart illustrating a process 400 for IP routing and forwarding operation and management of an IP router node in accordance with some example embodiments of the present disclosure. The process 400 may involve the terminal device 121-1, the SMF entity 126, the PCF entity 129 and the TSCTSF 125 as illustrated in FIG. 1. Although the process 400 will be described in the communication environment 100 of FIG. 1, this process may be likewise applied to other communication scenarios.

In the process 400, the DS-TT 121-2 is not provided and the at least one first IP interface is associated with the terminal device 121-1. Each of the first and third subset of IP routing or forwarding information comprises static IP routing or forwarding information about the at least one first IP interface.

As shown in FIG. 4, the TSCTSF 125 is preconfigured with the first static routing information. When the terminal device 121-1 establishes a PDU session per UE/DS-TT DetNet interface (i.e., the first IP interface), the terminal device 121-1 may indicate support for IP routing entry exchange. The terminal device 121-1 may provide information about the at least one first IP interface it has, at minimum some identifier for each first IP interface the terminal device 121-1 locally uses.

The terminal device 121-1 may transmit 410 to the SMF entity 126 the first subset of IP routing or forwarding information about the at least on first IP interface within PDU session establishment or modification procedure. In some embodiments, the terminal device 121-1 may transmit a Non-Access Stratum Session Management (NAS SM) signaling to the SMF entity 126. The NAS SM signaling comprises the first subset of IP routing or forwarding information. In turn, the SMF entity 126 exposes 420 the first subset of IP routing or forwarding information to the TSCTSF 125 directly or to the TSCTSF 125 via the PCF entity 129.

Based on the first subset of IP routing or forwarding information and the first static routing information pre-configured on the TSCTSF 125, the TSCTSF 125 may determine 430 the third subset of IP routing or forwarding information about the at least one first IP interface associated with the terminal device 121-1.

In some embodiments, the first subset of IP routing or forwarding information may comprise the framed routes information and IP routing or forwarding information received from the terminal device 121-1. In such embodiments, the TSCTSF 125 may determine the third subset of IP routing or forwarding information about the at least one first IP interface based on the framed routes information, the IP routing or forwarding information received from the terminal device 121-1 and the first static routing information pre-configured on the TSCTSF 125.

In turn, the TSCTSF 125 may transmit 440 the third subset of IP routing or forwarding information to the SMF entity 126. In other words, the TSCTSF 125 may update these routes (their IP prefixes) to the SMF entity 126, so that the SMF entity 126 will update the UPF N3 forwarding for them to the correct PDU session.

In turn, the SMF entity 126 may transmit 450 the third subset of IP routing or forwarding information to the terminal device 121-1 so as to configure the at least one first IP interface with the third subset of IP routing or forwarding information. In some embodiments, the SMF entity 126 may transmit an NAS SM signaling to the terminal device 121-1. The NAS SM signaling comprises the third subset of IP routing or forwarding information.

With the process 400, at least in some cases especially the DS-TT device 121-2 and/or the NW-TT 127-2 are omitted, there would still be a way for the TSCTSF 125 (or some other NF) to learn and configure 5GS with external routing information.

In embodiments where the at least one first IP interface is associated with the terminal device 121-1 and each of the first and third subset of IP routing or forwarding information comprises static IP routing or forwarding information about the at least one first IP interface, alternatively, the SMF entity 126 may obtain the framed routes information from the UDM entity 122 and provide the framed routes information to the terminal device 121-1. For example, the SMF entity 126 may provide the framed routes information to the terminal device 121-1 during PDU session establishment or modification procedure.

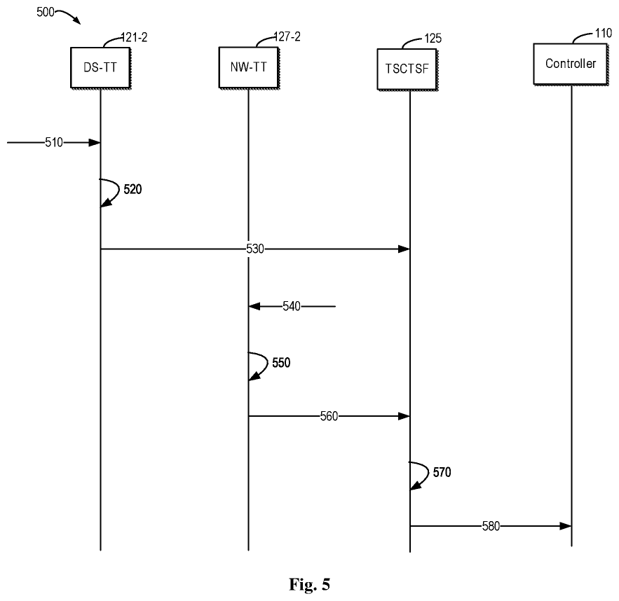

FIG. 5 illustrates a signaling chart illustrating a process 500 for IP routing and forwarding operation and management of an IP router node in accordance with some example embodiments of the present disclosure. The process 500 may involve the DS-TT device 121-2, the NW-TT 127-2, the TSCTSF 125 and the router controller 110 as illustrated in FIG. 1. Although the process 500 will be described in the communication environment 100 of FIG. 1, this process may be likewise applied to other communication scenarios.

In the process 500, the at least one first IP interface is associated with the DS-TT device 121-2, and the at least one second IP interface is associated with the NW-TT device 127-2. Each of the first, second, third and fourth subsets of IP routing or forwarding information comprises dynamic IP routing or forwarding information about the at least one first IP interface.

As shown in FIG. 5, the DS-TT 121-2 receives 510 IP routing protocol messages, for example, from the second set of IP entities 130. After the DS-TT 121-2 receives the IP routing protocol or algorithm messages, the DS-TT 121-2 processes 520 the IP routing protocol or algorithm messages to determine the first subset of IP routing or forwarding information associated with the at least one first IP interface.

In some embodiments, the DS-TT 121-2 may build-up or maintain local IP routing information base to store the first subset of IP routing or forwarding information. In turn, the DS-TT 121-2 transmits 530 the first subset of IP routing or forwarding information to the TSCTSF 125 via PMIC. In some embodiments, PMIC may be carried via the UE 121-1, the SMF 126 and the PCF 129.

The NW-TT 127-2 receives 540 IP routing protocol or algorithm messages, for example, from the third set of Entities 140. Then, the NW-TT 127-2 processes 550 the IP routing protocol or algorithm messages to determine the second subset of IP routing or forwarding information associated with the at least one second IP interface. In some embodiments, the NW-TT 127-2 may build-up or maintain local IP routing information base to store the second subset of IP routing or forwarding information. In turn, the NW-TT 127-2 transmits 560 the second subset of IP routing or forwarding information to the TSCTSF 125 via PMIC or UMIC. With UMIC, all interfaces could be carried in the same container rather than putting it interface-by-interface to PMIC. In some embodiments, PMIC/UMIC may be carried via the N4, the SMF 126 and the PCF 129 but other kind of transfer are possible such as a direct transfer between UPF 127-1 to TSCTSF 125.

Upon receiving at least one of the first and second subsets of IP routing or forwarding information which is dynamic IP routing or forwarding information, the TSCTSF 125 determines 570 the second set of IP routing or forwarding information.

In some embodiments, the TSCTSF 125 may integrate the dynamic IP routing or forwarding information received in the process 500 and the static IP routing or forwarding information received in the process 300 or 400. In turn, the TSCTSF 125 may determine integrated IP routing or forwarding information as the second set of IP routing or forwarding information.

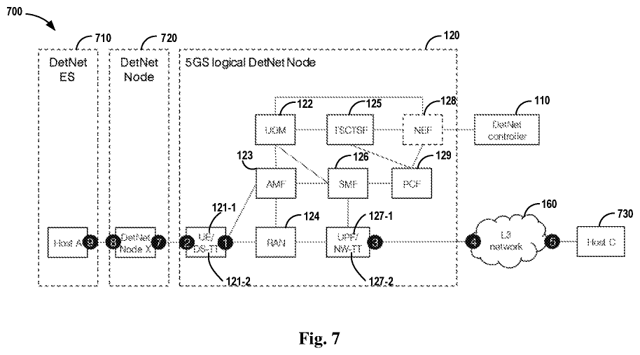

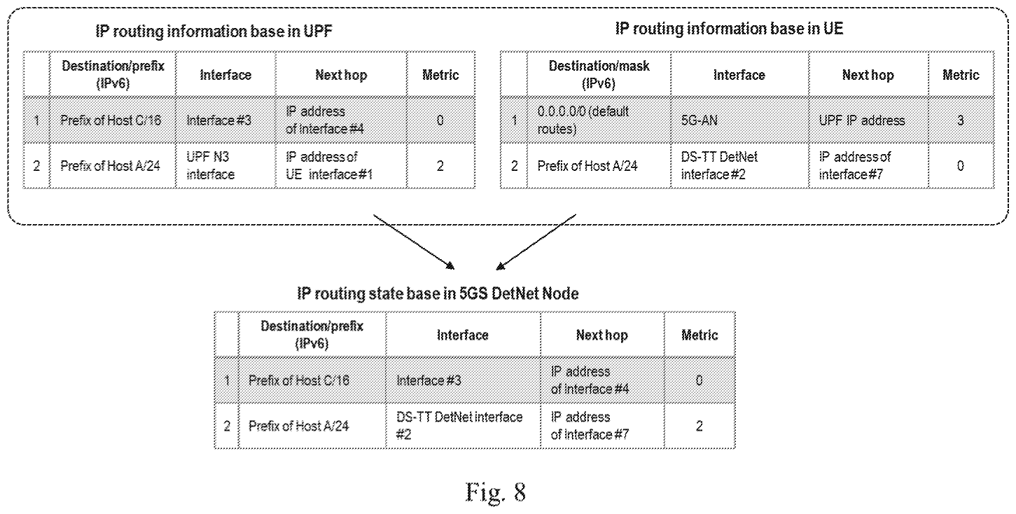

In some embodiments, the TSCTSF 125 may determine an IP routing status base for the first IP router node 120 based on the second set of IP routing or forwarding information. Details on how the TSCTSF 125 determines the IP routing status base will be described later with reference to FIGS. 7 and 8.

Upon determining the second set of IP routing or forwarding information, the TSCTSF 125 may transmit 580 the second set of IP routing or forwarding information to the IP router controller 110. In some embodiments, the TSCTSF 125 may transmit the determined IP routing status base for the first IP router node 120 to the IP router controller 110, optionally via the NEF entity 128 (which is not shown in FIG. 5). In some embodiments, the format of the IP routing status base may follow IETF RFC 8349.

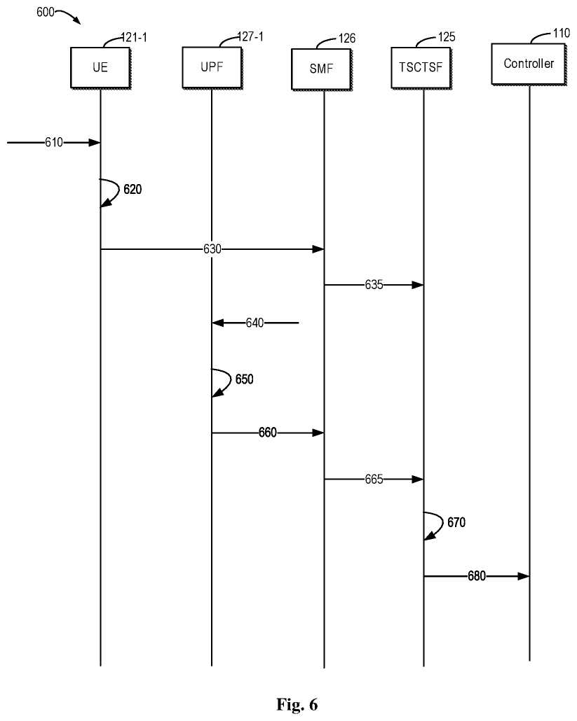

FIG. 6 illustrates a signaling chart illustrating a process 600 for IP routing and forwarding operation and management of an IP router node in accordance with some example embodiments of the present disclosure. The process 600 may involve the terminal device 121-1, the UPF entity 127-1, the SMF 126, the TSCTSF 125 and the router controller 110 as illustrated in FIG. 1. Although the process 600 will be described in the communication environment 100 of FIG. 1, this process may be likewise applied to other communication scenarios.

In the process 600, the at least one first IP interface is associated with the terminal device 121-1, and the at least one second IP interface is associated with the UPF entity 127-1. Each of the first, second, third and fourth subsets of IP routing or forwarding information comprises dynamic IP routing or forwarding information about the at least one first IP interface.

As shown in FIG. 6, after the terminal device 121-1 receives 610 IP routing protocol or algorithm messages, the terminal device 121-1 processes 620 the IP routing protocol or algorithm messages to determine the first subset of IP routing or forwarding information associated with the at least one first IP interface. In some embodiments, the terminal device 121-1 may build-up or maintain local IP routing information base to store the first subset of IP routing or forwarding information. In turn, the terminal device 121-1 transmits 630 the first subset of IP routing or forwarding information to the SMF 126 via a NAS SM signaling. Then, the SMF 126 transmits 635 the first subset of IP routing or forwarding information to the TSCTSF 125 via PCF service.

When the UPF entity 127-1 and the SMF entity 126 establish their Packet Control Forwarding Protocol (PCFP) association, the UPF entity 127-1 may indicate to the SMF entity 126 it supports IP routing entry exchange. The UPF entity 127-1 may provide information on the N6 interfaces it has, at minimum some identifier for each interface it locally uses.

After the UPF entity 127-1 receives 640 IP routing protocol or algorithm messages, the UPF entity 127-1 processes 650 the IP routing protocol or algorithm messages to determine the second subset of IP routing or forwarding information associated with the at least one second IP interface. In some embodiments, the UPF entity 127-1 may build-up or maintain local IP routing information base to store the second subset of IP routing or forwarding information. In turn, the UPF entity 127-1 transmits 660 the second subset of IP routing or forwarding information to the SMF 126 via a PCFP signaling. Then, the SMF 126 transmits 665 the second subset of IP routing or forwarding information to the TSCTSF 125 via NPCF service.

It will be understood that although the second subset of dynamic IP routing or forwarding information is described with reference to FIG. 6, in other embodiments, the UPF entity 127-1 may transmit the second subset of static IP routing or forwarding information to the SMF 126 via a PCFP signaling. In turn, the SMF 126 may transmit the second subset of static IP routing or forwarding information to the TSCTSF 125 via NPCF service.

Upon receiving at least one of the first and second subsets of IP routing or forwarding information which is dynamic IP routing or forwarding information, the TSCTSF 125 determines 670 the second set of IP routing or forwarding information.

In some embodiments, the TSCTSF 125 may integrate the dynamic IP routing or forwarding information received in the process 600 and the static IP routing or forwarding information received in the process 300 or 400. In turn, the TSCTSF 125 may determine integrated IP routing or forwarding information as the second set of IP routing or forwarding information.

In some embodiments, the TSCTSF 125 may determine an IP routing status base for the first IP router node 120 based on the second set of IP routing or forwarding information. Details on how the TSCTSF 125 determines the IP routing status base will be described later with reference to FIGS. 7 and 8.

Upon determining the second set of IP routing or forwarding information, the TSCTSF 125 may transmit 680 the second set of IP routing or forwarding information to the IP router controller 110. In some embodiments, the TSCTSF 125 may transmit the determined IP routing status base for the first IP router node 120 to the IP router controller 110, optionally via the NEF entity 128 (which is not shown in FIG. 6). In some embodiments, the format of the IP routing status base may follow IETF RFC 8349.

In embodiments where the TSCTSF 125 obtains the first set of IP routing or forwarding information from the IP router controller 110, the TSCTSF 125 may configure the at least one IP interface by performing the following.

If the TSCTSF 125 determines an IP interface indicated by the first set of IP routing or forwarding information is one of the at least one first IP interface, the TSCTSF 125 may transmit the third subset of IP routing or forwarding information to the DS-TT device 121-2 associated with the one of the at least one first IP interface.

If the TSCTSF 125 determines an IP interface indicated by the first set of IP routing or forwarding information is one of the at least one second IP interface, the TSCTSF 125 may transmit the fourth subset of IP routing or forwarding information to the NW-TT device 127-2 associated with the one of the at least one second IP interface.

In embodiments where the TSCTSF 125 obtains the first set of IP routing or forwarding information from the IP router controller 110, alternatively, the TSCTSF 125 may configure the at least one IP interface at least one of the following: transmitting the third subset of IP routing or forwarding information about the at least one first IP interface to the terminal device 121-1 via the SMF entity 126; or transmitting the fourth subset of IP routing or forwarding information about the at least one second IP interface to the UPF entity 127-1 via the SMF entity 126.

As mentioned above, the TSCTSF 125 may determine an IP routing status base for the first IP router node 120 based on the second set of IP routing or forwarding information. Hereinafter, details on how the TSCTSF 125 determines the IP routing status base will be described with reference to FIGS. 7 and 8.

FIG. 7 illustrates another example communication environment 700 in which embodiments of the present disclosure can be implemented. As shown in FIG. 7, the communication environment 700 comprises the IP router controller 110 and the first set of entities 120 which have been described with reference to FIG. 1. In addition, the communication environment 700 comprises a fourth set of IP entities 710, a second set of IP entities 720 and a third set of IP entities 730.

The first set of entities 120 is connected with an IP router node X in the second set of IP entities 720 via the UE 121-1 or DS-TT device 121-2. Behind the IP router node X, there is one Host A in the fourth set of IP entities 710. The Host A may act as a DetNet End System(ES). A Host C in the third set of IP entities 730 takes the role of a DetNet ES and is connected to the UPF entity 127-1 or the NW-TT device 127-2 via the L3 network 160.

FIG. 8 illustrates an example of determining an IP routing status base for the first IP router node 120 in accordance with some embodiments of the present disclosure. As shown in FIG. 8, the TSCTSF 125 may obtain the IP routing information base in the UE 121-1 and the IP routing information base in the UPF entity 127-1. For example, the TSCTSF 125 may obtain the IP routing information base in the UE 121-1 and the IP routing information base in the UPF entity 127-1 from the DS-TT device 121-2 and the NW-TT 127-2 respectively, as described with reference to FIG. 5. For another example, the TSCTSF 125 may obtain the IP routing information bases from the UE 121-1 and the UPF entity 127-1 respectively, as described with reference to FIG. 6. Each of the obtained IP routing information bases may comprise static or dynamic IP routes.

In this example, taking dynamic routes as an example. The TSCTSF 125 may merge the built table rows of IP routing state base from the actions 530 and 560 in FIG. 5. Alternatively, the TSCTSF 125 may merge the built table rows of IP routing state base from the actions 635 and 665 in FIG. 6.

For the table rows with the same destination address, the TSCTSF 125 may remove the internal interface parameters of the obtained IP routing information base and replace them with corresponding egress interfaces of the first set of entities 120. For example, the TSCTSF 125 may replace the internal interface “5G-AN” with egress Interface 3, and the internal interface UPF N3 interface with DS-TT DetNet interface 2.

It will be understood that generally, IP Address Information may comprise at least one of the following: an IP address and a subnet mask (for IPv4); one or more IP prefixes and an interface identifier (ID) (for IPv6). The full IP address of an IP interface may be a concatenation of a prefix and an interface ID. The example of FIG. 8 has been described by taking IPv6 as an example.

In one preferred embodiment, if the different routes exist for the same destination IP address, the static one has a higher priority than the dynamic one (not shown in FIG. 8).

In some embodiments, the TSCTSF 125 may generate, based on at least one of the first set of IP routing or forwarding information and the first static routing information, at least one of the third subset of IP routing or forwarding information and the fourth subset of IP routing or forwarding information. The third subset of IP routing or forwarding information is about at least one first IP interface associated with the terminal device 121-1 or with the DS-TT device 121-2. The fourth subset of IP routing or forwarding information is about at least one second IP interface associated with the UPF entity 127-1 or with the NW-TT device 127-2. For example, the TSCTSF 125 may generate at least one of the third and fourth subsets of IP routing or forwarding information in a similar way to as described with reference to FIGS. 7 and 8.

As described above, the TSCTSF 125 may obtain or configure the routing or forwarding on the DS-TT device 121-2 and the NW-TT device 127-2 by using the PMIC or UMIC.

In some embodiments, the TSCTSF 125 may use the PMIC or UMIC procedures to read IP routing information base and/or write the static IP routing table entries and get updates (notifications) when they change. The TSCTSF 125 may read and get updates about the IP routes configured directly on the DS-TT device 121-2 and/or the NW-TT device 127-2 or obtained by dynamic routing protocols or algorithms. The TSCTSF 125 may write the IP route entries it has in its own routing configuration (static routes for the first IP router Node 120) and/or the explicit routes provided by the IP router controller or any other IP Soft Defined Network (SDN) controller.

With the DS-TT device 121-2, PMIC may be used in the context of a single DS-TT/UE interface. With the NW-TT device 127-2, one approach is to use UMIC so that it contains the forwarding table for all the NW-TT interfaces. In this approach, the forwarding table format must make it clear what is the outgoing interface for each prefix.

The same extensions apply to the information carried over NAS SM signaling between the UE 121-1 and the SMF entity 126 and using PCFP protocol between the UPF entity 127-1 and the SMF entity 126.

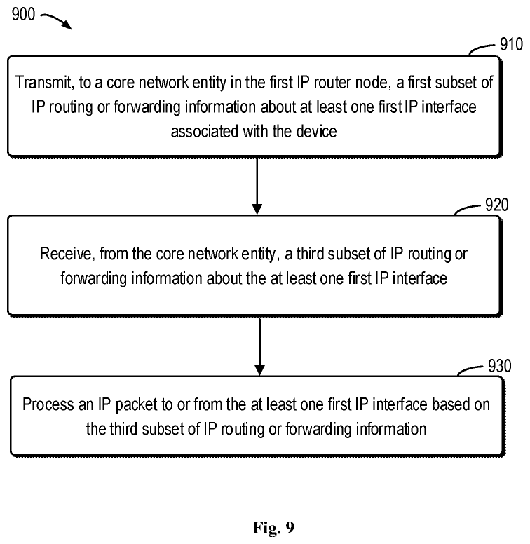

FIG. 9 shows a flowchart of an example method 900 implemented at a device in accordance with some example embodiments of the present disclosure. For example, the method 900 may be implemented at the terminal device 121-1 or the DS-TT 121-2 in FIG. 1.

At block 910, a device in a first set of entities acting as a first IP router node transmits, to a core network entity in the first IP router node, a first subset of IP routing or forwarding information about at least one first IP interface associated with the device.

At block 920, a device receives, from the core network entity, a third subset of IP routing or forwarding information about the at least one first IP interface.

In some embodiment, the first subset of IP routing or forwarding information may be static subset of IP routing or forwarding information. The third subset of IP routing or forwarding information may be determined based on at least one of the first set of IP routing or forwarding information and first static routing information preconfigured on the first core network entity within the IP router.

At block 930, a device processes an IP packet to or from the at least one first IP interface based on the third subset of IP routing or forwarding information.

In some embodiments, the device is a DS-TT device.

In some embodiments, the device may transmit the first subset of IP routing or forwarding information by transmitting a first Port Management Information Container, PMIC comprising the first subset of IP routing or forwarding information.

In some embodiments, the device may receive the third subset of IP routing or forwarding information by receiving a second Port Management Information Container, PMIC comprising the third subset of IP routing or forwarding information.

In some embodiments, each of the first and second PMIC comprises at least one of the following: an IP address, a range of IP addresses, a length of an IP prefix, a next hop IP address, or a type of the IP routing or forwarding information.

In some embodiments, the device is a terminal device. In such embodiments, the device may transmit the first subset of IP routing or forwarding information by transmit a Non-Access Stratum Session Management, NAS SM, signaling to the SMF, the NAS SM signaling comprising the first subset of IP routing or forwarding information.

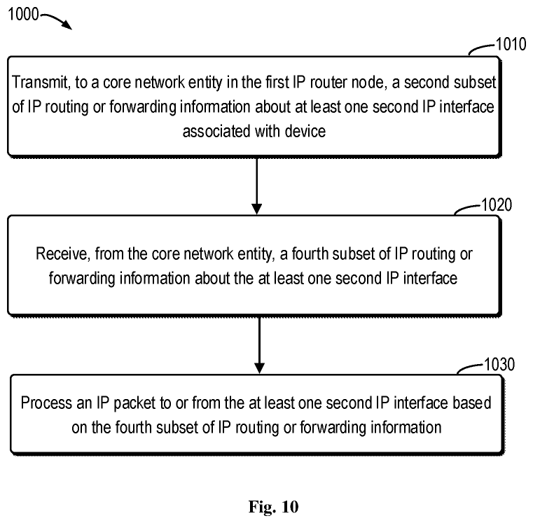

FIG. 10 shows a flowchart of an example method 1000 implemented at a device in accordance with some example embodiments of the present disclosure. For example, the method 1000 may be implemented at the UPF entity 127-1 or the NW-TT 127-2 in FIG. 1.

At block 1010, a device in a first set of entities acting as a first IP router node transmits, to a core network entity in the first IP router node, a second subset of IP routing or forwarding information about at least one second IP interface associated with the device.

At block 1020, the device receives, from the core network entity, a fourth subset of IP routing or forwarding information about the at least one second IP interface.

In some embodiment, the second subset of IP routing or forwarding information may be static subset of IP routing or forwarding information. The fourth subset of IP routing or forwarding information may be determined based on at least one of the first set of IP routing or forwarding information and first static routing information preconfigured on the core network entity.

At block 1030, the device processes an IP packet to or from the at least one second IP interface based on the fourth subset of IP routing or forwarding information.

In some embodiments, the device is a NW-TT device.

In some embodiments, the device may transmit the second subset of IP routing or forwarding information by transmitting a third PMIC or a first UMIC, the third PMIC or the first UMIC comprising the second subset of IP routing or forwarding information.

In some embodiments, the device may receive the fourth subset of IP routing or forwarding information by receiving a fourth PMIC or a second UMIC, the fourth PMIC or the second UMIC comprising the fourth subset of IP routing or forwarding information.

In some embodiments, each of the third and fourth PMICs and the first and second UMICs comprises at least one of the following: an IP address, a range of IP addresses, a length of an IP prefix, a next hop IP address, or a type of the IP routing or forwarding information.

In some embodiments, the device is a UPF entity.

In some embodiments, the device may transmit the second subset of IP routing or forwarding information by transmitting a PCFP signaling to an SMF entity in the first IP router node, the PCFP signaling comprising the second subset of IP routing or forwarding information.

In some example embodiments, an apparatus capable of performing any of the method 200 may comprise means for performing the respective steps of the method 200. The means may be implemented in any suitable form. For example, the means may be implemented in a circuitry or software module.

In some example embodiments, the apparatus comprises: means for obtaining, at a core network entity in a first set of entities acting as a first IP router node, first set of IP routing or forwarding information about at least one IP interface in the first IP router node from at least one of the following: at least one user plane entity in the first IP router node, at least one control plane entity in the first IP router node, or an IP router controller; and means for determining a second set of IP routing or forwarding information about the first IP router based on at least one of the first set of IP routing or forwarding information and first static routing information preconfigured on the core network entity, the at least one IP interface connecting the first IP router node to a second set of IP entities and/or to a third set of IP entities.

In some embodiments, the first set of IP routing or forwarding information comprises at least one of the following: a first subset of IP routing or forwarding information about at least one first IP interface associated with a terminal device in the first IP router node or with a DS-TT device associated with the terminal device; or a second subset of IP routing or forwarding information about at least one second IP interface associated with a UPF entity in the first IP router node or an NF-TT device associated with the UPF entity.

In some embodiments, the at least one control plane entity comprises a UDM entity; and means for obtaining the first subset of IP routing or forwarding information comprises means for obtaining framed routes information associated with the terminal device from a Unified Data Management, UDM, entity in the first IP router node.

In some embodiments, means for obtaining the framed routes information from the UDM entity via at least one of an SMF entity or a Policy control function in the first IP router node.

In some embodiments, the framed routes information comprises at least one of the following: a set of IP addresses reachable via the at least one first IP interface, a next hop IP address associated with the at least one first IP interface, and an identifier for the at least one first IP interface.

In some embodiments, the at least one user plane entity comprises the DS-TT device and means for obtaining the first subset of IP routing or forwarding information from the DS-TT device; or the at least one user plane entity comprises the terminal device and means for obtaining the first subset of IP routing or forwarding information from the terminal device.

In some embodiments, means for obtaining the first subset of IP routing or forwarding information comprises: means for receiving, from the DS-TT device, a PMIC comprising the first subset of IP routing or forwarding information.

In some embodiments, the at least one user plane entity comprises the NW-TT device and means for obtaining the second subset of IP routing or forwarding information from the NW-TT device; or the at least one user plane entity comprises the UPF entity and means for obtaining the second subset of IP routing or forwarding information from the UPF entity via an SMF entity in the first IP router node.

In some embodiments, means for obtaining the second subset of IP routing or forwarding information comprises: means for receiving, from the NW-TT device, a PMIC or a UMIC, the PMIC or the UMIC comprising the second subset of IP routing or forwarding information.

In some embodiments, the apparatus further comprises means for configuring the at least one IP interface based on the second set of IP routing or forwarding information.

In some embodiments, the apparatus further comprises means for generating, based on at least one of the first set of IP routing or forwarding information and the first static routing information, at least one of a third subset of IP routing or forwarding information and a fourth subset of IP routing or forwarding information; wherein the third subset of IP routing or forwarding information is about at least one first IP interface associated with a terminal device in the first IP router or with a DS-TT device associated with the terminal device; and the fourth subset of IP routing or forwarding information is about at least one second IP interface associated with a UPF entity in the first IP router node or with a NW-TT device associated with the UPF entity.

In some embodiments, means for configuring the at least one IP interface comprises: means for transmitting a PMIC to the IP interface of the DS-TT device, the PMIC comprising the third subset of IP routing or forwarding information.

In some embodiments, means for configuring comprises means for transmitting to the NW-TT device a PMIC or a UMIC, the PMIC or the UMIC comprising the fourth subset of IP routing or forwarding information.

In some embodiments, the PMIC or UMIC comprises at least one of the following: an IP address, a range of IP addresses, a length of an IP prefix, a next hop IP address, or a type of the IP routing or forwarding information.

In some embodiments, means for obtaining the first set of IP routing or forwarding information from the IP router controller; and means for configuring the at least one IP interface comprises: in accordance with a determination an IP interface indicated by the first set of IP routing or forwarding information is one of the at least one first IP interface, means for transmitting the third subset of IP routing or forwarding information to a Device DS-TT device associated with the one of the at least one first IP interface; and/or in accordance with a determination an IP interface indicated by the first set of IP routing or forwarding information is one of the at least one second IP interface, means for transmitting the fourth subset of IP routing or forwarding information to a NW-TT device associated with the one of the at least one second IP interface.

In some embodiments, means for obtaining the first set of IP routing or forwarding information from the IP router controller; and means for configuring the at least one IP interface comprises at least one of the following: means for transmitting the third subset of IP routing or forwarding information about the at least one first IP interface to the terminal device via an SMF entity; or means for transmitting the fourth subset of IP routing or forwarding information about the at least one second IP interface to the UPF entity via the SMF entity.

In some embodiments, the apparatus further comprises means for transmitting the second set of IP routing or forwarding information to the IP router controller.

In some example embodiments, an apparatus capable of performing any of the method 900 may comprise means for performing the respective steps of the method 900. The means may be implemented in any suitable form. For example, the means may be implemented in a circuitry or software module.

In some example embodiments, the apparatus comprises: means for transmitting, from a device in a first set of entities acting as a first IP router node to a core network entity in the first IP router node, a first subset of IP routing or forwarding information about at least one first IP interface associated with the device; means for receiving, from the core network entity, a third subset of IP routing or forwarding information about the at least one first IP interface, the third subset of IP routing or forwarding information being determined based on at least one of the first set of IP routing or forwarding information and first static routing information preconfigured on the first core network entity within the first IP router node; and means for processing an IP packet to or from the at least one first IP interface based on the third subset of IP routing or forwarding information.

In some embodiments, the apparatus may be a DS-TT device.

In some embodiments, the means for transmitting the first subset of IP routing or forwarding information comprises means for transmitting a first PMIC comprising the first subset of IP routing or forwarding information.

In some embodiments, the means for receiving the third subset of IP routing or forwarding information comprises means for receiving a second PMIC comprising the third subset of IP routing or forwarding information.

In some embodiments, each of the first and second PMIC comprises at least one of the following: an IP address, a range of IP addresses, a length of an IP prefix, a next hop IP address, or a type of the IP routing or forwarding information.

In some embodiments, the apparatus may be a terminal device. In such embodiments, the means for transmitting the first subset of IP routing or forwarding information comprises means for transmitting a Non-Access Stratum Session Management, NAS SM, signaling to the SMF, the NAS SM signaling comprising the first subset of IP routing or forwarding information.

In some example embodiments, an apparatus capable of performing any of the method 1000 may comprise means for performing the respective steps of the method 1000. The means may be implemented in any suitable form. For example, the means may be implemented in a circuitry or software module.

In some example embodiments, the apparatus comprises: means for transmitting, from the apparatus in a first set of entities acting as a first IP router node to a core network entity in the first IP router node, a second subset of IP routing or forwarding information about at least one second IP interface associated with the apparatus; means for receiving, from the core network entity, a fourth subset of IP routing or forwarding information about the at least one second IP interface, the fourth subset of IP routing or forwarding information being determined based on at least one of the first set of IP routing or forwarding information and first static routing information preconfigured on the core network entity; and means for processing an IP packet to or from the at least one second IP interface based on the fourth subset of IP routing or forwarding information.

In some embodiments, the apparatus may be an NW-TT device.

In some embodiments, the means for transmitting the second subset of IP routing or forwarding information comprises means for transmitting a third PMIC or a first UMIC, the third PMIC or the first UMIC comprising the second subset of IP routing or forwarding information.

In some embodiments, the means for receiving the fourth subset of IP routing or forwarding information comprises means for receiving a fourth PMIC or a second UMIC, the fourth PMIC or the second UMIC comprising the fourth subset of IP routing or forwarding information.

In some embodiments, each of the third and fourth PMICs and the first and second UMICs comprises at least one of the following: an IP address, a range of IP addresses, a length of an IP prefix, a next hop IP address, or a type of the IP routing or forwarding information.

In some embodiments, the apparatus may be a UPF entity.

In some embodiments, the means for transmitting the second subset of IP routing or forwarding information comprises means for transmitting a PCFP signaling to an SMF entity in the first IP router node, the PCFP signaling comprising the second subset of IP routing or forwarding information.

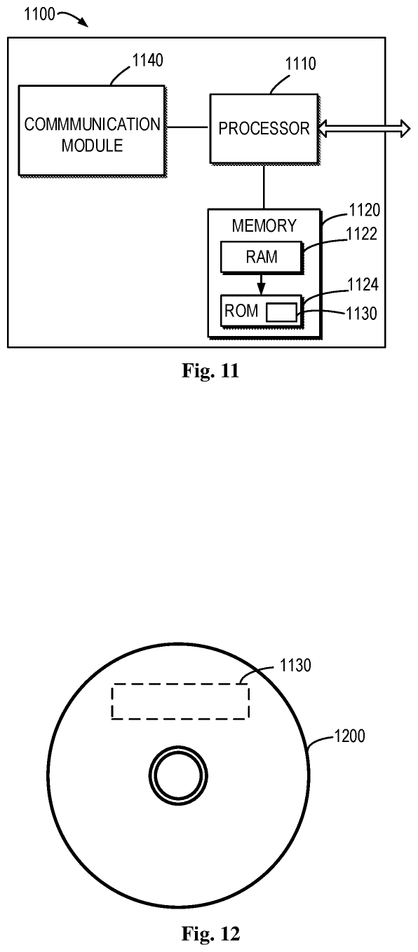

FIG. 11 is a simplified block diagram of a device 1100 that is suitable for implementing embodiments of the present disclosure. The device 1100 may be provided to implement the communication device, for example, the TSCTSF 125, the terminal device 121-1, the DS-TT device 121-2, the UPF entity 127-1 or the NW-TT device 127-2 as shown in FIG. 1. As shown, the device 1100 includes one or more processors 1110, one or more memories 1120 coupled to the processor 1110, and one or more communication modules 1140 coupled to the processor 1110.

The communication module 1140 is for bidirectional communications. The communication module 1140 has at least one antenna to facilitate communication. The communication interface may represent any interface that is necessary for communication with other network elements.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The program 1130 may be stored in the ROM 1124. The processor 1110 may perform any suitable actions and processing by loading the program 1130 into the RAM 1122.

The embodiments of the present disclosure may be implemented by means of the program 1130 so that the device 1100 may perform any process of the disclosure as discussed with reference to FIGS. 1 to 10. The embodiments of the present disclosure may also be implemented by hardware or by a combination of software and hardware.

In some example embodiments, the program 1130 may be tangibly contained in a computer readable medium which may be included in the device 1100 (such as in the memory 1120) or other storage devices that are accessible by the device 1100. The device 1100 may load the program 1130 from the computer readable medium to the RAM 1122 for execution. The computer readable medium may include any types of tangible non-volatile storage, such as ROM, EPROM, a flash memory, a hard disk, CD, DVD, and the like. FIG. 12 shows an example of the computer readable medium 1200 in form of CD or DVD. The computer readable medium has the program 1130 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 200, 900 and 1000 as described above with reference to FIGS. 2, 9 and 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A core network entity, comprising:
at least one processor; and
at least one memory including computer program code;
wherein the at least one memory and the computer program code are configured to, with the at least one processor, cause the core network entity in a first set of entities acting as a first Internet Protocol, IP, router node to:
obtain a first set of IP routing or forwarding information about at least one IP interface in the first IP router node from:
at least one user plane entity in the first IP router node, and
determine a second set of IP routing or forwarding information about the first IP router based on the first set of IP routing or forwarding information, the at least one IP interface connecting the first IP router node to a second set of IP entities and/or to a third set of IP entities, each of the IP entities comprising an IP node or an IP host.

2. The core network entity of claim 1, wherein the core network entity is further caused to:
transmit the second set of IP routing or forwarding information to the IP router controller.

3-10. (canceled)

11. The core network entity of claim 4, wherein:
the at least one user plane entity comprises the NW-TT device and the core network entity is caused to obtain the second subset of IP routing or forwarding information from the NW-TT device; or
the at least one user plane entity comprises the UPF entity and the core network entity is caused to obtain the second subset of IP routing or forwarding information from the UPF entity via a Session Management Function, SMF, entity in the first IP router node.

12. The core network entity of claim 11, wherein the core network entity is caused to obtain the second subset of IP routing or forwarding information by:
receiving, from the NW-TT device, a Port Management Information Container, PMIC or a User plane node Management Information Container, UMIC, the PMIC or the UMIC comprising the second subset of IP routing or forwarding information.

13-16. (canceled)

17. The core network entity of claim 10, wherein the PMIC or UMIC comprises at least one of the following:
an IP address,
a range of IP addresses,
a length of an IP prefix,
a next hop IP address, or
a type of the IP routing or forwarding information.

18-19. (canceled)

20. A device, comprising:
at least one processor; and
at least one memory including computer program code;
wherein the at least one memory and the computer program code are configured to, with the at least one processor, cause the device in a first set of entities acting as a first Internet Protocol, IP, router node to:
transmit, to a core network entity in the first IP router node, a first subset of IP, routing or forwarding information about at least one first IP interface associated with the device;
receive, from the core network entity, a third subset of IP routing or forwarding information about the at least one first IP interface; and
process an IP packet to or from the at least one first IP interface based on the third subset of IP routing or forwarding information.

21. The device of claim 20, wherein the device is a Device Side Time-Sensitive Networking translator, DS-TT, device.

22. The device of claim 21, wherein the device is caused to transmit the first subset of IP routing or forwarding information by:
transmitting a first Port Management Information Container, PMIC comprising the first subset of IP routing or forwarding information.

23. The device of claim 21, wherein the device is caused to receive the third subset of IP routing or forwarding information by:
receiving a second Port Management Information Container, PMIC comprising the third subset of IP routing or forwarding information.

24. The device of claim 22, wherein each of the first and second PMIC comprises at least one of the following:
an IP address,
a range of IP addresses,
a length of an IP prefix,
a next hop IP address, or
a type of the IP routing or forwarding information.

25. The device of claim 20, wherein the device is a terminal device.

26-28. (canceled)

29. A device, comprising:
at least one processor; and
at least one memory including computer program code;
wherein the at least one memory and the computer program code are configured to, with the at least one processor, cause the device in a first set of entities acting as a first Internet Protocol, IP, router node to:
transmit, to a core network entity in the first IP router node, a second subset of IP, routing or forwarding information about at least one second IP interface associated with the device;
receive, from the core network entity, a fourth subset of IP routing or forwarding information about the at least one second IP interface; and
process an IP packet to or from the at least one second IP interface based on the fourth subset of IP routing or forwarding information.

30. The device of claim 29, wherein the device is a Network Side Time-Sensitive Networking translator, NW-TT, device.

31. The device of claim 30, wherein the device is caused to transmit the second subset of IP routing or forwarding information by:
transmitting a third Port Management Information Container, PMIC, or a first User plane node Management Information Container, UMIC, the third PMIC or the first UMIC comprising the second subset of IP routing or forwarding information.

32. The device of claim 30, wherein the device is caused to receive the fourth subset of IP routing or forwarding information by:
receiving a fourth Port Management Information Container, PMIC or a second User plane node Management Information Container, UMIC, the fourth PMIC or the second UMIC comprising the fourth subset of IP routing or forwarding information.

33. The device of claim 31, wherein each of the third and fourth PMICs and the first and second UMICs comprises at least one of the following:
an IP address,
a range of IP addresses,
a length of an IP prefix,
a next hop IP address, or
a type of the IP routing or forwarding information.

34. The device of claim 29, wherein the device is a User Plane Function, UPF, entity.

35. The device of claim 34, wherein the device is caused to transmit the second subset of IP routing or forwarding information by:
transmitting a Packet Control Forwarding Protocol, PCFP, signaling to a Session Management Function, SMF, entity in the first IP router node, the PCFP signaling comprising the second subset of IP routing or forwarding information.

36. The device of claim 29, wherein the second subset of IP routing or forwarding information is updated based on the fourth subset of IP routing or forwarding information.

37-43. (canceled)
